(19) United States
(12) Patent Application Publication
(10) Pub. No.: US 2011/0300874 A1
(43) Pub. Date: Dec. 8, 2011

(54) SYSTEM AND METHOD FOR REMOVING TDMA AUDIO NOISE

(75) Inventor: Shaohai Chen, Cupertino, CA (US)

(73) Assignee: Apple Inc., Cupertino, CA (US)

(21) Appl. No.: 12/794,524

(22) Filed: Jun. 4, 2010

(51) Int. Cl. H04W 72/08

(52) U.S. Cl. 455/452.2

(57) ABSTRACT

A system and method for removing time division multiple access (TDMA) noise from an audio signal during a silence interval and not during a non-silence interval. An audio silence interval may be a set of frames which have substantially no audible sound (i.e. no speech or voice are audible). This may be determined by analyzing the decibel level or magnitude of the audio signal. In one embodiment, a voice activity detector determines a silence interval within the audio signal and sends a control signal to enable a TDMA noise filter. The audio signal is continuously passed through the TDMA noise filter. However, the TDMA noise filter only operates/processes the silence intervals of the audio signal as a result of the TDMA noise filter being activated by the voice activity detector.

### BACKGROUND

An embodiment of the invention generally relates to methods and systems for removing time division multiple access (TDMA) noise from an audio signal. Other embodiments are also described.

Numerous wireless telephone carriers throughout the world operate their networks using a TDMA based protocol. For example, TDMA based protocols are used in digital cellular systems such as Global System for Mobile Communications (GSM), IS-136, Personal Digital Cellular (PDC), Integrated Digital Enhanced Network (iDEN), and in the Digital Enhanced Cordless Telecommunications (DECT) standard for mobile phones. TDMA protocols are also used extensively in satellite systems and combat-net radios. Because of their inherent transmission efficiency and varied applications, TDMA protocols are widely used throughout the world.

Although TDMA based wireless network systems efficiently provide network communications to a distributed user set, audio call quality may suffer as a result of TDMA audio noise. TDMA audio noise (also referred to as a “buzz”) in mobile phones is caused by the radio section of a TDMA mobile phone transitioning between transmission and reception modes. For instance, in the GSM protocol, this transition occurs 217 times per second or 217 Hz, which is in the audible frequency range. The TDMA transitioning produces an audible noise through a speaker when it interacts with the audio path of the mobile phone. The noise is not only present in the speakers or earpieces of the mobile phone of a near-end user in which it originated, but it may also be picked up by a microphone on the originating mobile phone and then carried in an uplink signal, together with speech of the near-end user, to a receiving phone where it may be heard by the far-end user as well. In this case, the far-end user may hear the TDMA audio noise in a speaker or earpiece of the receiving phone even though the receiving phone is not necessarily a TDMA based mobile phone.

In an effort to remove TDMA audio noise from mobile phone communications. Different solutions have been suggested. For instance, electrical power supply path isolation techniques have been described that decouple the radio transceiver of a TDMA based mobile phone from its audio processing circuitry. In another instance, a notch (or band stop) filter has been incorporated into the uplink signal path of a TDMA based mobile phone to remove the 217 Hz content. In another solution, the uplink audio signal is continuously passed through a software based speech frame noise cancellation process (similar to active noise control).

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a diagram of a near-end mobile phone and a far-end phone operating in a near-end network and a far-end network, respectively.

FIG. 2 is a diagram of one embodiment of a time division multiple access (TDMA) audio noise cancellation system.

FIG. 3 is an example audio signal that may be analyzed by a silence interval detector.

FIG. 4 is a method for removing TDMA noise from a downlink audio signal frames in a mobile phone.

FIG. 5 is a method for removing TDMA noise from an uplink audio signal frames in a mobile phone.

### SUMMARY

Time division multiple access (TDMA) based wireless network systems efficiently provide network communications to a distributed user set. However, audio call quality may suffer as a result of TDMA audio noise. The suggested audio filter solutions, while removing the TDMA noise content, may adversely affect the human-perceived quality of the speech content. To more effectively remove the TDMA audio noise, an embodiment of the invention is directed to a system and method in a mobile phone, for detecting silence intervals in audio signal frames and activating a TDMA noise filter only during those silence intervals.

In one embodiment, an audio silence interval is a set of one or more signal frames which have substantially no audible sound. This may be determined by analyzing the decibel level, magnitude, or energy level of an audio signal frame in accordance with known voice activity detection techniques. Once a silence interval or non-speech frame has been detected in an audio signal, a control signal is sent or asserted to enable a TDMA noise filter and the audio signal frame is passed through the TDMA noise filter. This continues with subsequent frames, so long as they have been classified as silence or non-speech frames. When a subsequent non-silence or speech frame is detected, a control signal is not sent or asserted to enable the TDMA noise filter and the frames bypasses the TDMA noise filter that is deactivated. Thus, the TDMA noise filter only processes the silence or non-speech intervals of the audio signal, and not the speech intervals, because the TDMA noise filter is only activated (to process speech or audio frames) during non-speech intervals of the audio signal.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### DETAILED DESCRIPTION

Several embodiments of the invention with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

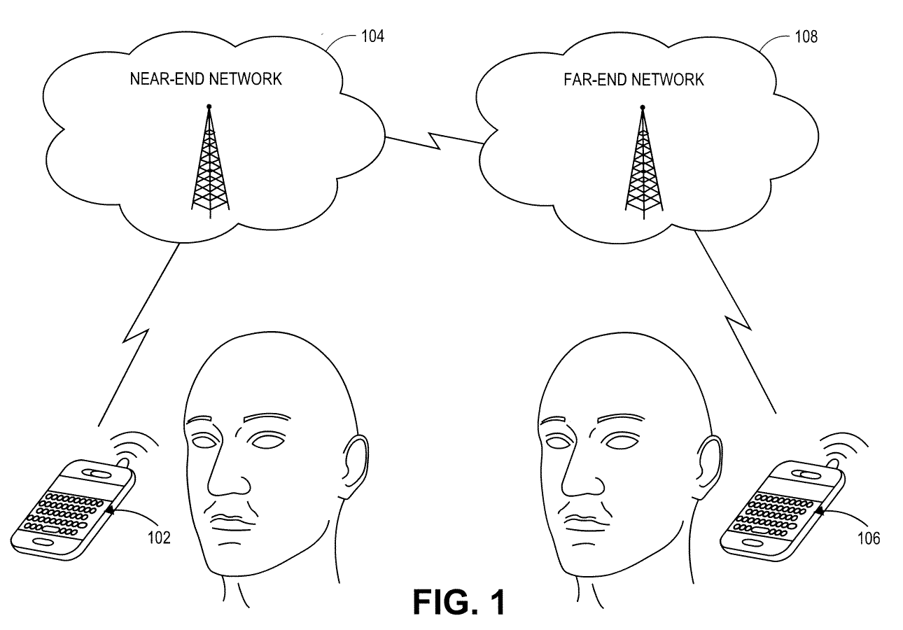

FIG. 1 depicts a near-end mobile phone 102 that utilizes a time division multiple access (TDMA) protocol. In one embodiment, the mobile phone 102 is a Global System for Mobile Communications (GSM) radio. The near-end mobile phone 102 may be a personal digital assistant, a smart phone, or any similar apparatus that is able to connect to a near-end network 104 to communicate with a far-end phone 106. For example, the near-end mobile phone 102 may be an iPhone™ device by Apple Inc. The phone 102 has a housing in which the primary mechanism for visual and tactile interaction with its user is a touch sensitive display screen. As an alternative, a physical keyboard may be provided together with a display-only screen. The housing may be essentially a solid volume, often referred to as a candy bar or chocolate bar type, as in the iPhone™ device. An alternative is one that has a moveable, multi-piece housing such as a clamshell design, or one with a sliding, physical keypad as used by other cellular and mobile handset or smart phone manufacturers. The touch screen displays typical features of visual voicemail, web browser, email, and digital camera viewfinder, as well as telephony features such as a virtual telephone number keypad (which may receive input from the user via virtual buttons and touch commands, as opposed to the physical keyboard option).

The user-level functions of the near-end mobile phone 102 are implemented under control of an application processor that has been programmed in accordance with instructions (code and data) stored in memory, e.g. microelectronic, non-volatile random access memory. The processor and memory are generically used here to refer to any suitable combination of programmable data processing components and data storage that can implement the operations needed for the various functions of the device described here. An operating system may be stored in the memory, along with application programs to perform specific functions of the device (when they are being run or executed by the processor). In particular, there is a telephony application that (when launched, unsuspended, or brought to foreground) enables the near-end user of the near-end mobile phone 102 to “dial” a telephone number or address of a far-end phone 106 of a far-end user to initiate a call using, for instance, a cellular protocol, and then to “hang-up” the call when finished.

The near-end network 104 may be any type of network that uses a TDMA protocol such that the near-end mobile phone 102 may operate within the network 104. For example, the near-end network 104 may be a GSM, IS-136, Personal Digital Cellular (PDC), Integrated Digital Enhanced Network (iDEN), or Digital Enhanced Cordless Telecommunications (DECT) network. The near-end mobile phone 102 and the near-end network 104 in which the mobile phone 102 operates may utilize a variety of different voice CODECs. For example, the mobile phone 102 and the near-end network 104 may utilize Half Rate, Full Rate, Enhanced Full Rate, Adaptive Multi-Rate, or Adaptive Multi-Rate Narrowband voice CODECs.

The far-end phone 106 may be any type of phone. For example, the far-end phone 106 may be a mobile/cellular phone (e.g. GSM, CDMA, LTE, WiMAX, etc.), a landline phone, a satellite phone, a voice over IP phone (eg. Skype™), or any other similar type of phone that is capable of connecting to the far-end network 108. The far-end network 108 may be any type of phone network. For example, the far-end network 108 may be a mobile/cellular network (e.g. GSM, CDMA, LTE, WiMAX, etc.), a landline network (e.g. POTS), a satellite network, a voice over IP network (eg. Skype™), or any other similar type of network.

The far-end phone 106 connects to the far-end network 108 such that it may make a voice call to the near-end mobile phone 102 and the near-end mobile phone 102 may make a voice call to the far-end phone. The terms “call” and “telephony” are used here generically to refer to any two-way real-time or live voice communication session with a far-end user. The call is being conducted through one or more communication networks 3, e.g. a wireless cellular network, a wireless local area network, a wide area network such as the Internet, and a public switch telephone network such as the plain old telephone system (POTS). The far-end user need not be using a mobile device 2, but instead may be using a landline based POTS or Internet telephony station.

In one embodiment, the near-end network 104 and the far-end network 108 are the same network. In another embodiment, the near-end network 104 and the far-end network 108 are separate networks. In this embodiment, the near-end network 104 and the far-end network 108 communicate with each other such that the near-end mobile phone 102 and the far-end phone 106 may communicate with each other by routing calls through both networks 104 and 108.

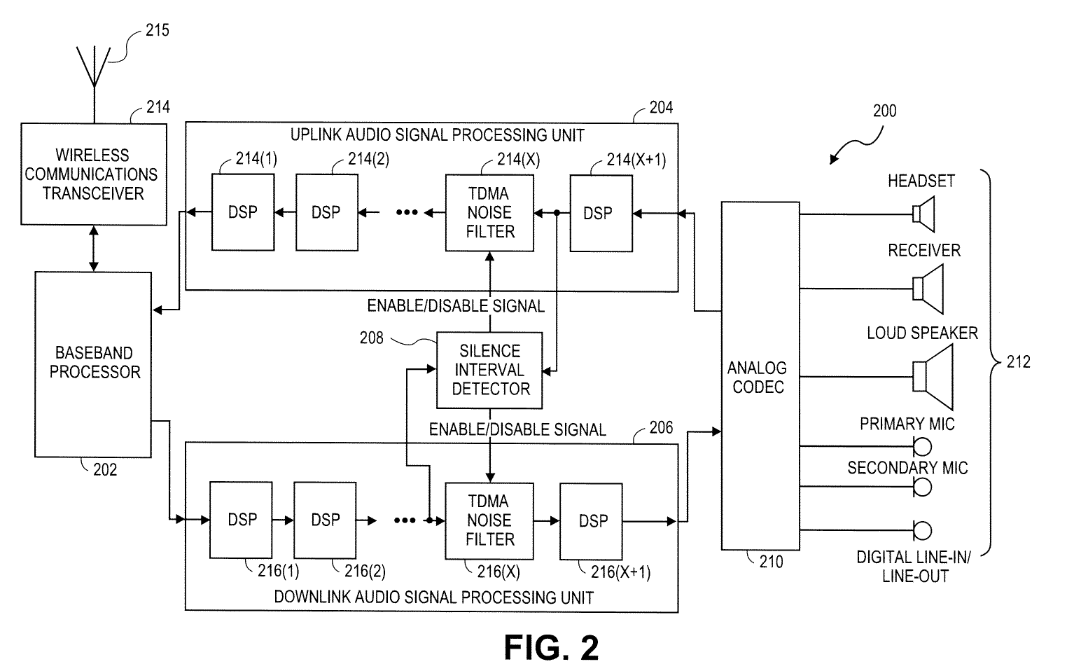

FIG. 2 depicts one embodiment of a TDMA audio noise cancellation system 200 which may be used with audio signals of the near-end mobile phone 102. The TDMA audio noise cancellation system 200 may be integrated in the near-end mobile phone 102 or it may be externally coupled to the near-end mobile phone 102. In one embodiment, the TDMA audio noise cancellation system 200 is externally coupled to the near-end mobile phone 102 using IEEE 1394, Universal Serial Bus (USB), an Apple dock connector, or any similar physical connection medium supported by the near-end mobile phone 102.

The embodiment of the TDMA audio noise cancellation system 200 shown in FIG. 2 includes a baseband processor 202, an uplink signal processing unit 204, a downlink signal processing unit 206, a voice activity detector 208, an analog codec 210, and a set of transducers 212. Each of these elements of the TDMA audio noise cancellation system 200 will be described below by way of example.

The set of transducers 212 may include any transducer that is capable of being integrated into a mobile phone. For example, the set of transducers 212 may include a primary microphone, a secondary microphone, a receiver, a loud speaker (e.g. a speaker phone), a headset (e.g. a wired headset or wireless Bluetooth headset), and a digital line-in and/or line-out connector (e.g. IEEE 1394, Universal Serial Bus (USB), and an Apple dock connector). The set of transducers 212 are connected to the analog codec 210 through data lines within the near-end mobile phone 102.

The analog codec 210 provides several data conversion functions, including analog-to-digital conversion and digital-to-analog conversion. In one embodiment, the analog codec 210 receives a digital audio signal from the downlink signal processing unit 206. The analog codec 210 converts this digital signal into an analog signal that may be output through appropriate analog transducers from the set of transducers 212 (e.g. receivers, loud speakers, and headsets). In one embodiment, the analog codec 210 may receive an analog signal containing audio voice frames from one or more of the set of transducers 212. The analog codec 210 converts these analog signals into a digital signal that may be transmitted through the uplink signal processing unit 204 and baseband processor 202 to the far-end phone 106. In still another embodiment, the analog codec receives a digital audio signal from the downlink signal processing unit 206. The analog codec 210 converts this digital signal into a formatted digital signal that may be output through appropriate digital transducers from the set of transducers 212 (e.g. a digital line-out connector).

The baseband processor 202 is a processor which implements the telecommunications stack of the near-end mobile phone 102. For example, the baseband processor 202 may implement the GSM stack. The baseband processor 202 may perform speech coding and decoding and channel coding and decoding. In one embodiment, the baseband processor 202 may include a cellular communications transceiver 214 which modulates and demodulates a radio frequency signal received from an antenna 215.

In one embodiment, the baseband processor 202 is implemented using a general purpose processor within the near-end mobile phone 102. In another embodiment, the baseband processor 202 is a separate, dedicated processor apart from a general purpose processor in the near-end mobile phone 102. In this embodiment, the baseband processor 202 is provided with dedicated random access memory and data lines in the near-end mobile phone 202 such that the baseband processor 202 may operate independently from other processors in the near-end mobile phone 202. In some embodiments, the baseband processor 202 is an S-Gold 2 baseband processor, an X-Gold 608 baseband processor, or a similar type of processor.

The baseband processor 202 is coupled to the uplink signal processing unit 204 and the downlink signal processing unit 206 through a series of data lines. The baseband processor 202 receives audio signal frames from the uplink signal processing unit 204 and performs speech and channel coding on the audio signal frames prior to transmitting the coded audio frames through an antenna of the near-end mobile phone 102. Conversely, the baseband processor 202 receives coded audio frames through the antenna of the near-end mobile phone 102. After receipt, the baseband processor 202 performs speech and channel decoding on the audio signal frames audio signal frames and transmits the decoded audio signal frames to the downlink signal processing unit 206.

In one embodiment, the uplink signal processing unit 204 and the downlink signal processing unit 206 perform various digital signal processing operations on the audio signal frames using digital signal processors 216, 218. The digital signal processors 216, 218 enhance the audio payload contained within the audio signal frames by performing various digital transformation and conversions. For example, digital signal processors 216, 218 may perform speech enhancement processing on the audio signal packets, e.g. one or more of the following: mixing, acoustic echo cancellation, noise suppression, channel automatic gain control, compaction and expansion, and equalization.

In one embodiment, the TDMA audio noise cancellation system 200 includes a TDMA noise filter. The TDMA noise filter may be separate and distinct from the uplink signal processing unit 204 and the downlink signal processing unit 206. In this embodiment, a single TDMA noise filter may be used for both the uplink signal processing unit 204 and the downlink signal processing unit 206.

In another embodiment, one of the digital signal processors 216, 218 in each of the uplink signal processing unit 204 and the downlink signal processing unit 206 is a TDMA noise filter. As shown in FIG. 2, the digital signal processors 216(X), 218(X) are TDMA noise filters.

The TDMA noise filters filter input audio signals to remove selected waveforms. In one embodiment, the TDMA noise filters are notch filters (i.e. a band limit filter, a T-notch filter, a band-elimination filter, a band-reject filter, etc.). As used herein, a notch filter is a filter that passes all frequencies except those in a stop band centered on a center frequency. These frequencies are effectively attenuated or removed from the input audio signals 216(X) and 218(X). In one embodiment, the centered frequency for the TDMA noise filters 216(X), 218(X) is 217 Hz, which produces an audible TDMA audio noise when coupled into the audio path of the near-end mobile phone 102. The TDMA noise filters may have multiple centered frequencies which are integer mutiples of 217 Hz (e.g. 217 Hz, 434 Hz, 651 Hz, 868 Hz, etc.).

The Q factor of the TDMA noise filters 216(X), 218(X) may vary depending on a user input value. For example, a user who determines that the TDMA audio noise heard in the near-end mobile phone 102 is high may input a lower Q value to greaten the threshold for removing the 217 Hz frequency while a user who determines that the TDMA audio noise heard in the near-end mobile phone 102 is low may input a higher Q value to lessen the threshold for removing the 217 Hz frequency.

In one embodiment, the TDMA noise filters 216(X), 218(X) may be toggled on and off (i.e. active and inactive). In the “on” state, the TDMA noise filters 216(X), 218(X) operate to remove a selected waveform from input audio signals as described above. In the “off” state, audio signals to bypass the TDMA noise filters 216(X), 218(X) without changing or altering the signals. In one embodiment, the TDMA noise filters 216(X), 218(X) receive activation/inactivation signals from the voice activity detector 208 to appropriately toggle the TDMA noise filters 216(X), 218(X) into the “on” state (i.e. active) or “off” state (i.e. inactive). In this embodiment, the TDMA noise filters 216(X), 218(X) are coupled to the voice activity detector 208 through data lines.

The voice activity detector 208 receives an input audio signal and analyses the input audio signal to determine intervals of silence and non-silence (i.e. speech and non-speech). In one embodiment, the input audio signal is the output of a digital signal processor 216, 218, the baseband processor 202 or the analog codec 210. As shown in FIG. 2, the voice activity detector 208 receives audio signals prior to the audio signals being input into the TDMA noise filters. The detector 208 analyzes these audio signals and determines an interval within the audio signals in which substantially no audible audio (i.e. no speech) is detected.

The voice activity detector 208 may detect a silence interval in the audio signal using any silence detection algorithm. In one embodiment, a decibel level may be defined by a user to determine whether silence is detected in the audio signals. For example, a user may select a decibel level of two decibels. In this example, an interval of an input audio signal that does not exceed two decibels is considered a silence interval. The use of two decibels in the above example is merely for illustration purposes. In other embodiments, other decibel levels or other audio signal characteristics may be examined to determine a silence interval.

Further, the user may select a time duration or number of audio frames that defines an interval for purposes of determining the silence interval. For example, the user may set an interval as three seconds. In this example, continuous three second intervals of the audio signal are analyzed to determine if the decibel level ever exceeds the user selected decibel level. If the decibel level of the input audio signal remains below the user selected decibel level for three seconds, the voice activity detector 208 sends a control signal (i.e. activation signal) to a respective TDMA noise filter 216(X), 218(X). In another example, the user may set an interval as ten frames. In this example, continuous sets of ten frames of the audio signal are analyzed to determine if the decibel level ever exceeds the user selected decibel level. If the decibel level of the input audio signal remains below the user selected decibel level for ten frames, the voice activity detector 208 sends a control signal (i.e. activation signal) to a respective TDMA noise filter 216(X), 218(X).

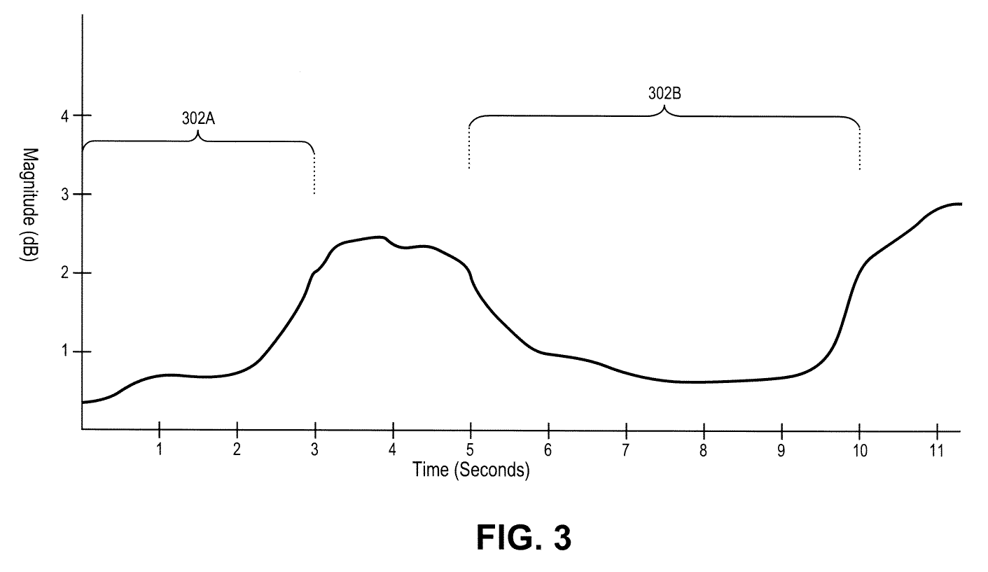

FIG. 3 is an example audio signal that has been analyzed by the voice activity detector 208. In this example, the user defined decibel level is two decibels and the user defined time interval is three seconds. As shown, intervals of the audio signal which remain below two decibels for at least three seconds are determined to be silence intervals 302A, 302B by the voice activity detector 208.

After the voice activity detector 208 determines a silence interval in an input audio signal, the voice activity detector 208 sends a control signal to the corresponding TDMA noise filter to cause the TDMA noise filter to operate on the corresponding detected silence interval to remove the selected waveform.

In one embodiment, the control signal indicates a time period of the detected silence interval such that the corresponding TDMA noise filter 216(X), 218(X) operates for the duration of the silence interval and subsequently enters an “off” state (i.e. deactivates). For example, in the audio signal of FIG. 3, the control signal corresponding to silence interval 302A indicates that silence interval 302A has a time period of three seconds while the control signal corresponding to silence interval 302B indicates that silence interval 302B has a time period of five seconds. In another embodiment, these time periods may be represented in terms of frame counts. Based on the respective control signals, the corresponding TDMA noise filter 216(X), 218(X) is in an “on” state for three seconds to operate on the silence interval 302A, then the TDMA noise filter 216(X), 218(X) enters an “off” state for two seconds while there is no silence interval in the audio signal, then the TDMA noise filter 216(X), 218(X) enters an “on” state for five seconds to operate on the silence interval 302B, and finally enters an “off” state until another silence interval is detected by the voice activity detector 208.

After the TDMA noise filter 216(X), 218(X) has operated on a silence interval of an audio signal and removed TDMA noise from the audio signal (i.e. removed or attenuated a selected waveform), the resulting TDMA de-noised audio signal is transmitted to the remaining digital signal processors 216, 218 in the uplink signal processing unit 204 or the downlink signal processing unit 206, respectively.

After being passed through the remaining digital signal processors 216 in the uplink signal processing unit 204, the de-noised audio signal is transmitted to the baseband processor 202. The baseband processor wraps the de-noised audio signal in an appropriate protocol and transmits the de-noised audio signal to near-end network 102 and ultimately to the far-end network 108 and the far-end phone 106. Conversely, after being passed through the remaining digital signal processors 218 in the downlink signal processing unit 206, the de-noised audio signal is transmitted to the analog codec 212. The analog codec 212 converts the digital de-noised audio signal into either an analog signal for corresponding analog transducers (e.g. a receiver, a loud speaker, and a headset) or a formatted digital signal capable of being used by a digital line-out.

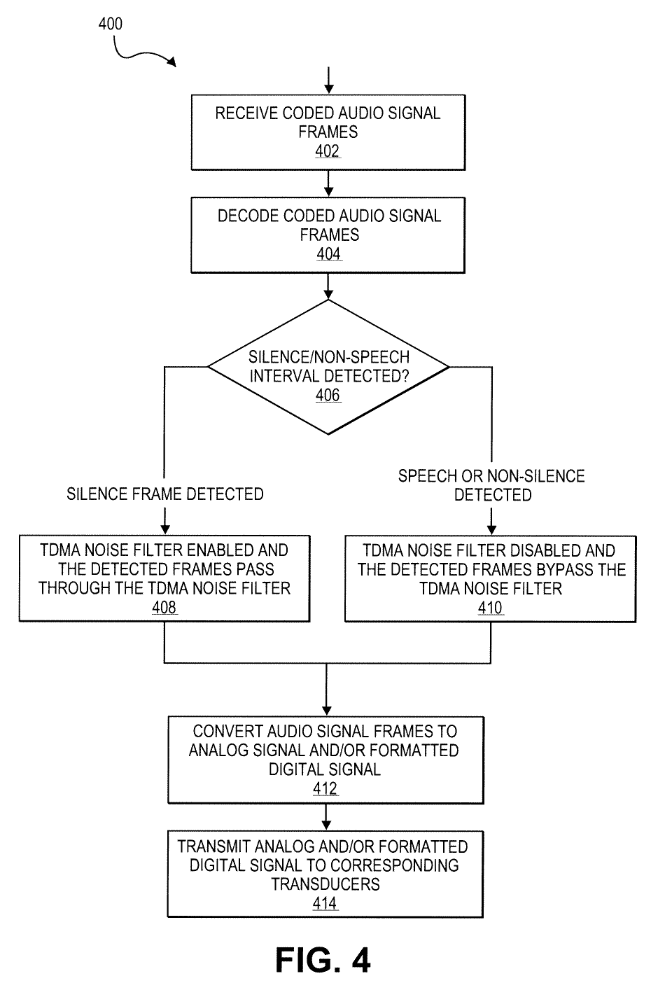

FIG. 4 shows a method for removing TDMA noise from downlink audio signal frames in a mobile phone 400. The method 400 commences after receiving coded audio signal frames at operation 402. The wrapped audio signal frames may be received by the near-end mobile phone 102 from the far-end phone 106 as shown in FIG. 1. In one embodiment, operation 402 is performed by the baseband processor 202.

Operation 404 decodes the coded audio signal frames to produce audio signal frames. The decoded audio signal frames may be decoded by removing TDMA protocol wrappers. In one embodiment, operation 404 is performed by the baseband processor 202.

Operation 406 detects if there is a silence or non-speech interval in the audio signal frames. A silence or non-speech interval is an interval (i.e. amount of time or number of frames) that has substantially no sound, voice or speech in the audio signal frames. In one embodiment, operation 406 is performed by the voice activity detector 208.

If a silence or non-speech interval is detected at operation 406, operation 408 transmits a control signal to the TDMA noise filter 218(X). The control signal activates/enables the TDMA noise filter 218(X) (i.e. puts the TDMA noise filter 218(X) in an “on” state) and the audio signal frames are passed through the TDMA noise filter 218(X). In one embodiment, operation 408 is performed by the voice activity detector 208.

If a non-silence or speech interval is detected at operation 406, operation 410 causes the audio signal frames to bypass or skip the TDMA noise filter 218(X). In one embodiment, operation 408 is performed by the voice activity detector 208.

For simplicity, the audio signal frames passing through the TDMA noise filter 218(X) or bypassing the TDMA noise filter 218(X) are hereinafter referred to as the de-noised audio signal frames.

Operation 412 converts de-noised audio signal frames from digital to analog such that they may be consumed by analog transducers (e.g. a receiver, a loud speaker, or a headset). Alternatively, operation 412 converts de-noised audio signal frames from a digital signal to a formatted digital signal that may be consumed by a digital line-out connector. In one embodiment, operation 412 is performed by analog codec 212.

Operation 414 transmits the analog and formatted digital signals produced at operation 412 to corresponding transducers. For example, the analog signal may be transmitted to analog transducers (e.g. a receiver, a loud speaker, or a headset) and the formatted digital signal may be transmitted to a digital transducer (e.g. a digital line-out connector). In one embodiment, operation 414 is performed by analog codec 212.

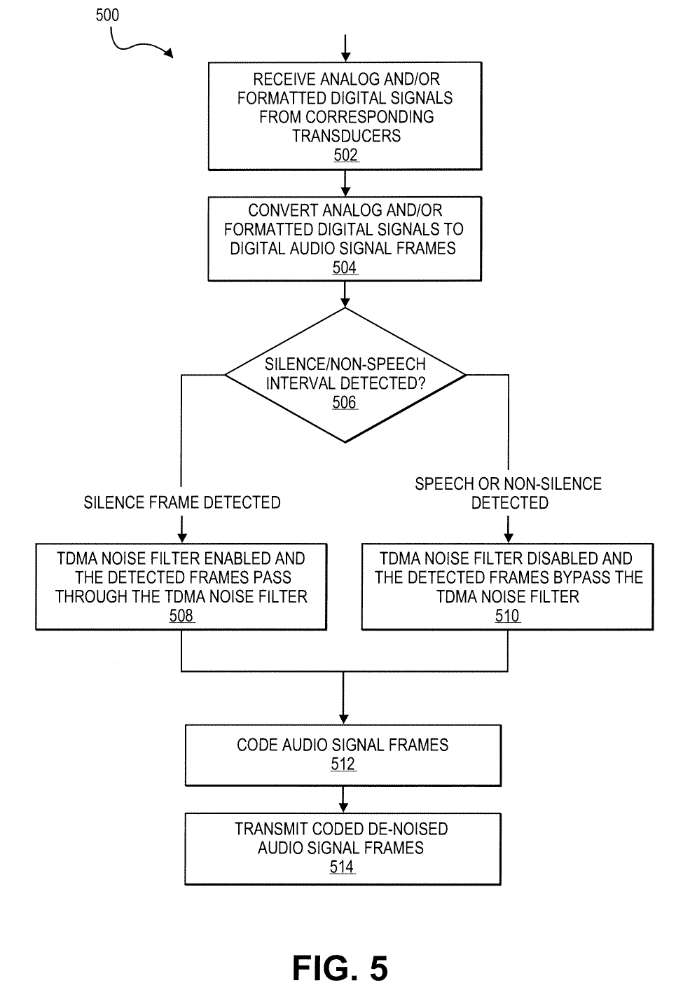

FIG. 5 shows a method for removing TDMA noise from uplink audio signal frames in a mobile phone 500. The method 500 commences after receiving an analog audio signal or a formatted digital signal from analog and digital transducers, respectively at operation 502. In one embodiment, the analog codec 212 performs operation 502 by receiving an analog signal from a microphone or of the near-end mobile phone 102 may send an analog signal or a formatted digital signal from a microphone or digital line-in integrated into the near-end mobile phone 102, respectively.

Operation 504 converts the received analog signal or formatted digital signal into digital audio signal frames. In one embodiment, operation 504 is performed by analog codec 212.

Operation 506 detects if there is a silence or non-speech interval in the audio signal frames. A silence or non-speech interval is an interval (i.e. amount of time or number of frames) that has substantially no sound or voice in the audio signal frames. In one embodiment, operation 506 is performed by the silence interval detector 208.

If a silence or non-speech interval is detected at operation 506, operation 508 transmits a control signal to the TDMA noise filter 216(X). The control signal activates/enables the TDMA noise filter (i.e. puts the TDMA noise filter 216(X) in an “on” state) and the audio signal frames are passed through the TDMA noise filter 218(X). In one embodiment, operation 508 is performed by the voice activity detector 208.

If a non-silence or speech interval is detected at operation 406, operation 510 causes the audio signal frames to bypass or skip the TDMA noise filter 216(X). In one embodiment, operation 508 is performed by the voice activity detector 208.

For simplicity, the audio signal frames passing through the TDMA noise filter 218(X) or bypassing the TDMA noise filter 218(X) are hereinafter referred to as the de-noised audio signal frames.

Operation 512 codes the de-noised audio signal frames for transmission the cellular communications transceiver 214 of the baseband processor 202. In one embodiment, operation 512 is performed by the baseband processor 202.

Operation 514 transmits the coded de-noised audio signal frames. In one embodiment, operation 514 is performed by the baseband processor 202.

To conclude, various aspects of a technique for removing TDMA noise from an audio signal during a silence interval and not during non-silence interval. As explained above, an embodiment of the invention may be a machine-readable medium such as one or more solid sate memory devices having stored thereon instructions which program one or more data processing components (generically referred to here as “a processor” or a “computer system”) to perform some of the operations described above. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although the system and process above have been described in terms of operating within a mobile phone, the operations may alternatively be performed in a landline based device. The description is thus to be regarded as illustrative instead of limiting.

What is claimed is:

1. A method for removing time division multiple access (TDMA) noise from an uplink or downlink audio signal in a mobile phone during a call, comprising:
accessing the uplink or downlink audio signal in the mobile phone;
detecting a plurality of silence intervals and a plurality of non-silence intervals in the audio signal; and
processing the audio signal by a TDMA noise removal filter during the detected silence intervals and not during the non-silence intervals.

2. The method of claim 1, wherein the audio signal is an uplink audio signal.

3. The method of claim 1, wherein the audio signal is a downlink audio signal.

4. The method of claim 1, wherein the noise removal filter is a notch filter.

5. The method of claim 4, wherein the notch filter has a first stop band centered at about 217 Hz and a second stop band centered at about 434 Hz.

6. The method of claim 1, further comprising:
sending a control signal to the TDMA noise removal filter to activate the TDMA noise removal filter.

7. The method of claim 1, wherein the control signal includes a duration for keeping the TDMA noise removal filter active.

8. A mobile phone, comprising:
an audio communications transceiver to receive an uplink or downlink audio signal during a call;
a voice activity detector for detecting non-speech segments and speech segments in the audio signal; and
a TDMA noise removal filter for processing the voice signal during the detected selected silence segments and not during the non-silence segments of the voice signal.

9. The mobile phone of claim 8, wherein the audio signal is an uplink audio signal.

10. The mobile phone of claim 8, wherein the audio signal is a downlink audio signal.

11. The mobile phone of claim 8, wherein the noise removal filter is a notch filter.

12. The mobile phone of claim 11, wherein the notch filter has a first stop band centered at about 217 Hz and a second stop band centered at about 434 Hz.

13. The mobile phone of claim 8, wherein the audio communications transceiver is a TDMA-based radio frequency cellular based network transceiver.

14. The mobile phone of claim 8, wherein the receiver is an analog codec.

15. An article of manufacture comprising:
a machine readable computer storage medium having stored instructions that program a computer system to:
accessing an uplink or downlink audio signal in a mobile phone during a call;
detecting a plurality of silence intervals and a plurality of non-silence intervals in the audio signal; and
processing the audio signal by a time division multiple access (TDMA) noise removal filter during the detected silence intervals and not during the non-silence intervals.

16. The article of manufacture of claim 15, wherein the audio signal is an uplink audio signal.

17. The article of manufacture of claim 15, wherein the audio signal is a downlink audio signal.

18. The article of manufacture of claim 15, wherein the noise removal filter is a notch filter.

19. The article of manufacture of claim 18, wherein the notch filter has a first stop band centered at about 217 Hz and a second stop band centered at about 434 Hz.

20. The article of manufacture of claim 15, wherein the detection of the one or more silence intervals comprises:
detecting the audio magnitude at one or more sample points in an interval of the audio signal; and
comparing the sample points with a predefined audio silence value.
